(19) United States
(12) Patent Application Publication
(10) Pub. No.: US 2022/0049757 A1
(43) Pub. Date: Feb. 17, 2022

(54) Gearwheel Arrangement for Electric Vehicle Transmissions

(71) Applicant: ZF Friedrichshafen AG, Friedrichshafen (DE)

(72) Inventors: Attila Szabo, Friedrichshafen (DE); Matthias Wesa, Ravensburg (DE)

(21) Appl. No.: 17/413,113

(22) PCT Filed: Nov. 21, 2019
(86) PCT No.: PCT/EP2019/082005

§ 371 Date: Jun. 11, 2021

(30) Foreign Application Priority Data
Dec. 14, 2018 (DE) 10 2018 221 824.2

(51) Int. Cl. F16H 1/06; F16H 55/08; F16H 55/17

(52) U.S. Cl. CPC F16H 1/06; B60K 1/00; F16H 55/17; F16H 55/08

(57) ABSTRACT

A gearwheel arrangement (16) for establishing a gear step in an electric vehicle transmission (17) includes a pinion (22) and an output gearwheel (23). The pinion (22) and the output gearwheel (23) are configured as spur gears and are meshed with each other in order to effect a transmission of a drive power of an electric machine (18). A ratio of a gearwheel diameter to a module of the output gearwheel (23) is in the range from 140 to 350. An electric vehicle transmission (17) with such a gearwheel arrangement (16) and a drive train (15) for an electric vehicle (10) with an electric machine (18), a differential (20), and such an electric vehicle transmission (17) are also provided.

### CROSS-REFERENCE TO RELATED APPLICATIONS

The present application is related and has right of priority to German Patent Application No. 102018221824.2 filed in the German Patent Office on Dec. 14, 2018 and is a nationalization of PCT/EP2019/082005 filed in the European Patent Office on Nov. 21, 2019, both of which are incorporated by reference in their entirety for all purposes.

### FIELD OF THE INVENTION

The present invention relates generally to a gearwheel arrangement for an electric vehicle transmission and to an electric vehicle transmission with such a gearwheel arrangement and to a drive train with such an electric vehicle transmission.

### BACKGROUND

Spur gear drives have advantages in the relatively simple design, since few moving parts are utilized and the externally toothed spur gears are comparatively easy to manufacture. One disadvantage is the small ratio, which is implementable in one step. In addition, a spur gear drive is larger and, thereby, also heavier than, for example, a planetary transmission given the same power transmission capacity. In order to implement large ratios with one pair of spur gears, the circumference of at least one gearwheel is kept small, whereas the circumference of the second gearwheel is kept large. The coverage, i.e., the number of teeth in engagement, becomes that much smaller, the smaller is at least one of the engaged gearwheels. It must therefore be ensured that the individual teeth always enter into engagement.

Gearwheels, which are utilized for transmitting turning motions and torques (power transmission) from an input shaft onto an output shaft, must be dimensionally stable with respect to radial forces that act upon a gearwheel, in particular, during the power transmission. The transmissions are exposed to enormous loads, in particular, during the utilization of electric prime movers that can reach very high rotational speeds, for example, in the range of twenty thousand (20,000) revolutions per minute. It is therefore known to implement larger ratios using at least two gearwheel pairs. Transmissions of this type have relatively high transmission losses, however. Moreover, transmissions of this type are less suitable for weight-relevant applications, such as, for example, racing, since the implementation by at least two gearwheel pairs is weight-intensive.

In general, it is desirable to design transmissions to be lightweight and with low losses in the transmission, in order to keep the total weight of a vehicle low and to increase a drive force-transmission in the drive train. A weight reduction is usually associated with a loss of the efficiency of the transmission. In particular in the case of high-loaded lightweight transmissions, it is known that all parts involved in the force transmission elastically deform, as the result of which gear meshing interferences and increased transmission losses can be induced.

### BRIEF SUMMARY OF THE INVENTION

Example aspects of the present invention provide a weight-optimized gearwheel arrangement with the lowest possible losses for an electric vehicle transmission, and an electric vehicle transmission and a drive train. In particular, a gearwheel arrangement, an electric vehicle transmission, and a drive train are to be created, which are suitable for use in electric motorsports due to their properties with respect to low weight and high stability even at very high rotational speeds.

The invention relates, in a first example aspect, to a gearwheel arrangement for establishing a gear step in an electric vehicle transmission, with a pinion and an output gearwheel, wherein:

the pinion and the output gearwheel are designed as spur gears, which are in engagement with each other, in order to effect a transmission of a drive power of an electric machine; and

a ratio of a gearwheel diameter with respect to a module of the output gearwheel is in the range from one hundred and forty (140) to three hundred and fifty (350), preferably in the range from two hundred and five (205) to three hundred and fifteen (315), and particularly preferably in the range from two hundred and five (205) to two hundred and thirty (230).

In one further example aspect, the invention relates to an electric vehicle transmission with an above-described gearwheel arrangement, wherein the electric vehicle transmission has a single gear step, which is established by the gearwheel arrangement.

In one further example aspect, the invention relates to a drive train for an electric vehicle with an electric machine, a differential, and an electric vehicle transmission as described above, wherein:

the pinion is arranged at an output shaft of the electric machine in a rotationally fixed manner; and

the output gearwheel is arranged at an output shaft or a differential of the drive train in a rotationally fixed manner, in order to establish a drive force-transmission path from the electric prime mover via the gear stage to the output shaft or the differential.

It is understood that the features, which are mentioned above and which will be described in greater detail in the following, are usable not only in the particular combination indicated, but also in other combinations or alone, without departing from the scope of the present invention. In particular, the electric vehicle transmission and/or the drive train can be designed according to the example embodiments described for the gearwheel arrangement.

Due to a ratio of a gearwheel diameter with respect to a module of the output gearwheel in the range from one hundred and forty (140) to three hundred and fifty (350), a high ratio can be achieved by the gearwheel arrangement according to example aspects of the invention. Simultaneously, the transmission losses, i.e., losses of the drive power, that are caused by the ratio in the transmission, are kept low. Preferably, a further gearwheel pair for a further gear step can be omitted. Due to a selection of the ratio of the gearwheel diameter with respect to a module of the output gearwheel in the range from two hundred and five (205) to three hundred and fifteen (315), the machinability of the gearwheel can be improved, since low modules are technically more complex to implement. Due to the selection of the ratio of the gearwheel diameter with respect to a module of the output gearwheel in the range from two hundred and five 205 to two hundred and thirty (230), a compromise can be found between the machinability of the gearwheel and the ratio in a gearwheel arrangement. In addition, an electric vehicle transmission with an above-described gearwheel arrangement can achieve a high ratio using only one gearwheel pair, and so the transmission is weight-optimized. Due to a rotationally fixed connection of an output shaft of the electric machine with the pinion and a rotationally fixed connection of an output shaft or a differential with the output gearwheel, the drive train for an electric vehicle can be relatively simply designed, with few parts. Moreover, this configuration results in a weight-optimized drive train, since further gearwheels can be omitted. The number of meshing points can be reduced, as the result of which transmission losses can be reduced. Due to the utilization of a single gear step, the meshing points and, thereby, the losses due to tooth meshing in the entire transmission can be halved. Overall, the total losses in the transmission are drastically reduced given a similar acoustic acceptance. The transmission can be made narrower, more cost-effective, and more efficient. The overall efficiency can become very high, in particular over ninety-nine percent (99%).

In one preferred example embodiment, the pinion and the output gearwheel have a module in the range from one millimeter (1.0) mm to one and eight-tenths millimeter (1.8 mm), preferably in the range from one millimeter (1.0 mm) to one and fifty-three hundredths millimeter (1.53 mm), and particularly preferably of one and fifty-one hundredths millimeter (1.51 mm). Due to the selection of a module in the range from one millimeter (1.0 mm) to one and eight-tenths millimeter (1.8 mm), the rolling losses on the gearwheel teeth and, thereby, the transmission losses, can be kept low. Due to a selection of the module in the range from one millimeter (1.0 mm) to one and fifty-three hundredths millimeter (1.53 mm), a preferred range can be found, which permits sufficient power to be transmitted by the gearwheel teeth, without the need to accept high transmission losses. Due to the selection of a module of one and fifty-one hundredths millimeter (1.51 mm), a preferred compromise can be found between the machinability of the gearwheel, the transmission of sufficient drive force/torque, and the reduction of the transmission losses.

In one further preferred example embodiment, the ratio of the gear step is greater than five and a half (5.5), in particular greater than eight (8.0), and particularly preferably equal to eight and nine-tenths (8.9). Due to the selection of a ratio (i_Stufe) of the gear step of greater than five and a half (5.5), a high ratio can be implemented using only one gearwheel pair. Due to a ratio of greater than eight (8.0), a torque and/or speed ratio can be implemented in a wide range using only one gearwheel arrangement. For example, a high ratio of the torque of a high-torque electric machine can be achieved. Moreover, a high reduction ratio of the rotational speed of an electric machine can take place. A high reduction ratio is advantageous, in particular, for race vehicles, which are designed for maximum speed and a light weight. Race vehicles are preferably equipped with lightweight electric machines, which preferably reach high rotational speeds. A ratio of eight and nine-tenths (8.9) represents a compromise between quickly pulling away from rest and an achievable maximum speed as a function of the rotational speed of the electric machine. Moreover, a ratio of eight and nine-tenths (8.9) yields an advantageous relationship of weight and ratio.

In one further preferred embodiment, the pinion and the output gearwheel have a pressure angle in the range from twenty degrees (20°) to twenty-eight degrees (28°), preferably from twenty-two degrees (22°) to twenty-six degrees (26°), and particularly preferably of twenty-four degrees (24°). Due to the selection of the pressure angle α_{wt} (alpha_wt) in the range from twenty degrees (20°) to twenty-eight degrees (28°), the flank load-carrying capacity can be increased and, thereby, the durability of the gearwheel arrangement can be improved. Due to the selection of the pressure angle in the range from twenty-two degrees (22°) to twenty-six degrees (26°), a flank load-carrying capacity of the teeth and, thereby, a durability of the gearwheel arrangement can be further improved, without shortening a contact path of the teeth by too great of an extent, and so a sufficiently low noise level is ensured. Due to the selection of the pressure angle of twenty-four degrees (24°), a preferred compromise can be found between the load-carrying capacity of the root and of the flank, i.e., the durability of the gearwheel arrangement, and the noise level.

In one further advantageous example embodiment, the pinion and/or the output gearwheel have/has a tooth depth in the range from one millimeter 1.0 mm to two and a half millimeters (2.5 mm), in particular in the range from one and two-tenths millimeter (1.2) mm to two millimeters (2.0 mm), and particularly preferably of one and a half millimeter (1.5 mm). Alternatively or additionally, the pinion and/or the output gearwheel can be made of metal, in particular of case-hardened steel. Alternatively or additionally, the pinion and/or the output gearwheel also have/has an involute profile, preferably with an addendum modification. Due to the selection of the tooth depth of the pinion and/or of the output gearwheel in the range from one millimeter (1.0 mm) to two and a half millimeters (2.5 mm), a sufficient meshing of teeth for the gearwheel arrangement can be achieved. Due to the selection of the tooth depth in the range from one and two-tenths millimeter (1.2 mm) to two millimeters (2.0 mm), a compromise can be found between the machinability of the gearwheel and a sufficient meshing of teeth. Due to the selection of a tooth depth of one and a half millimeter (1.5 mm), the gearwheel arrangement can have sufficient meshing of teeth in combination with efficient machinability. In addition, the rolling losses of the teeth of the gearwheel arrangement and, thereby, of the electric vehicle transmission are low. Due to the formation of the gearwheel arrangement from metal, preferably from case hardened steel, the durability of the gearwheel arrangement can be increased. Due to the provision of an involute profile, preferably with an addendum modification, the rolling behavior of the teeth of the gearwheel arrangement can be improved. The losses in the gearwheel arrangement can be further reduced.

In one further advantageous embodiment, the pinion has a diameter in the range from three centimeters (3.0 cm) to six and two-tenths centimeters (6.2 cm), in particular in the range from three and two-tenths centimeters (3.2 cm) to four and two-tenths centimeters (4.2 cm), and particularly preferably of three and a half centimeters (3.5 cm). Alternatively or additionally, the output gearwheel has a gearwheel diameter in the range from twenty-six centimeters (26 cm) to thirty-four centimeters (34 cm), in particular in the range from twenty-eight centimeters (28 cm) to thirty-two centimeters (32 cm), and particularly preferably of thirty-one and forty-eight hundredths centimeters (31.48 cm). Due to the selection of the diameter of the pinion in a range from three centimeters (3.0 cm) to six and two-tenths centimeters (6.2 cm) and of the output gearwheel in the range from twenty-six centimeters (26 cm) to thirty-four centimeters (34 cm), a sufficient meshing of teeth between the gearwheels of the gearwheel arrangement is ensured. Due to the selection of the diameter of the pinion in the range from three and two-tenths centimeters (3.2 cm) to four and two-tenths centimeters (4.2 cm) and of the gearwheel diameter of the output gearwheel in the range from twenty-eight centimeters (28 cm) to thirty-two centimeters (32 cm), a compromise can be found between the size of the gearwheel arrangement and the meshing of teeth, and so the gearwheel arrangement can be optimized with respect to weight, without the need to accept losses with respect to the meshing of teeth. Due to the selection of the diameter of the pinion of three and a half centimeters (3.5 cm) and/or of the gearwheel diameter of the output gearwheel of thirty-one and forty-eight hundredths centimeters (31.48 cm), a sufficient meshing of teeth can be ensured in combination with low extension and, thereby, low weight of the gearwheel pair. Moreover, the gearwheels of the gearwheel arrangement are technically easily machinable.

In one further advantageous embodiment, a center distance between a center of the pinion and a center of the output gearwheel is in the range from fourteen and a half centimeters (14.5 cm) to twenty centimeters (20.0 cm), preferably in the range from seventeen centimeters (17.0 cm) to eighteen and a half centimeters (18.5 cm), and particularly preferably in the range from seventeen and a half centimeters (17.5 cm) to eighteen centimeters (18.0 cm). Due to the selection of the center distance in the range from fourteen and a half centimeters (14.5 cm) to twenty centimeters (20.0 cm), a high ratio can be implemented by means of the gearwheel arrangement using only one gearwheel pair. Due to the selection of the center distance in the range from seventeen centimeters (17.0 cm) to eighteen and a half centimeters (18.5 cm), a compromise can be found between a ratio of the gear step of the gearwheel arrangement and the stability of the transmission shafts and bearings that are associated with the gearwheel arrangement. The mounting is made difficult as the center distance increases. In addition, the stability and, in particular, the quiet running of a gearwheel pair decrease. Due to the selection of the center distance in the range from seventeen and a half centimeters (17.5 cm) to eighteen centimeters (18.0 cm), a preferred compromise can be found between the stability of the gearwheel arrangement and the ratio in the gear step by the gearwheel arrangement.

In one further advantageous example embodiment, the gearwheel arrangement includes an input shaft and an output shaft. The pinion is arranged at the input shaft and the output gearwheel is arranged at the output shaft. The shafts are each mounted in shaft bearings, wherein a spacing distance of the bearings is predefined by a holding fixture, in order to establish a maximum distance between the shafts. Due to the provision of a holding fixture, it can be ensured that the gearwheels of the gearwheel arrangement remain in engagement during operation. In particular, a movement apart from each other due to different coefficients of linear expansion of the materials utilized in an electric vehicle transmission can be thwarted. Preferably, the holding fixture is designed to be rigid, wherein an expansion coefficient of a material of the holding fixture corresponds to an expansion coefficient of a material of the two gearwheels of the gearwheel arrangement. It is also conceivable to provide a bandage, which is arranged around the shaft bearings, in order to establish a maximum distance between the shafts. Preferably, an expansion coefficient of the material of the bandage is lower than an expansion coefficient of a material of a transmission housing of the electric vehicle transmission. The holding fixture and/or the bandage can be cast into a casting of the transmission housing or bonded, bolted, staked, or riveted with the transmission housing, pressed into the transmission housing, and/or welded with the transmission housing. In particular, it is conceivable to extrusion-coat the holding fixture or the bandage with lightweight construction materials, in particular plastic and/or fiber composite.

The gearwheel arrangement according to example aspects of the invention can also be advantageously utilized for establishing a gear step in other areas of application. In particular, an application in rail transport (trains, streetcars, etc.), in wind power (transmissions for wind turbines), and in armament (tanks, large equipment, etc.) is conceivable. The advantages of the arrangement according to example aspects of the invention can also be utilized in these areas of application.

The module m is the ratio between the reference diameter of the gearwheel and the number of teeth of the gearwheel. The reference diameter is the diameter of an imaginary cylinder, which extends through the center of the teeth. The reference circle is defined as a circle, the center of which is situated on the gearwheel axis, which extends through the pitch point of the gearwheel teeth. This pitch point is located between the root of the gearwheel tooth (root diameter) and the tip of the gearwheel tooth (outside diameter). The module, therefore, is a measure for the distance between two adjacent gearwheel teeth. The gearwheel diameter is to be understood, in particular, as the outside diameter in the present case.

Gearwheels can be designed and machined with an addendum modification. In the process, the shape of the teeth is changed, although without changing the underlying base curve. In the case of a gearwheel with an addendum modification, as compared to a gearwheel without an addendum modification, another part of the same curve is utilized as the tooth flank. In the case of gearwheels with addendum modification (often also referred to as “corrected gearwheels”), the outside diameter and the root diameter change by 2*x*m.

### BRIEF DESCRIPTION OF THE DRAWINGS

Example aspects of the invention are described and explained in greater detail in the following with reference to a few selected exemplary embodiments in conjunction with the attached drawings, in which:

FIG. 1 shows a schematic of an electric vehicle with an electric vehicle transmission with a gearwheel arrangement according to an example embodiment of the present invention;

FIG. 2 shows a gearwheel arrangement with a gearwheel and a pinion;

FIG. 3 shows a schematic of a drive train with a gearwheel arrangement according to an example embodiment of the present invention;

FIG. 4 shows a schematic of a drive train with a gearwheel arrangement according to an example embodiment of the present invention; and

FIG. 5 shows a diagrammatic axial view of two teeth of a tooth system of a gearwheel according to an example embodiment of the invention.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

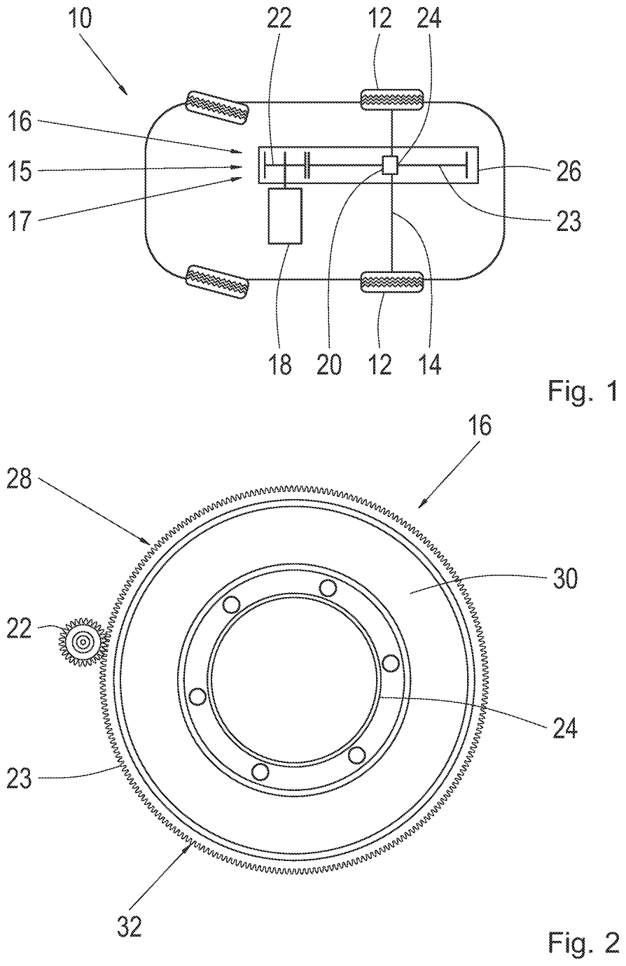

In FIG. 1, an electric vehicle 10 with driving wheels 12, a drive axle 14 operatively connected with the driving wheels 12, and a drive train 15 is diagrammatically shown. The schematic view of FIG. 1 corresponds to an aerial view of a sectional view. The relevant components are represented enlarged.

The drive train 15 includes an electric vehicle transmission 17 with a gearwheel arrangement 16 according to example aspects of the present invention, an electric machine 18, and a differential 20. The electric machine 18 is operatively connected with a pinion 22, which is in engagement with an output gearwheel 23, wherein the output gearwheel 23 is connected, at the gearwheel base 24, with the differential 20 in a rotationally fixed manner. By the differential 20, a drive force can be further transmitted to the driving wheels 12. The pinion 22, the output gearwheel 23, and the differential 20 can be accommodated in a transmission housing 26.

During an acceleration process in a driving operation, input power is made available in the drive train 15 by the electric machine 18 and is guided to the driving wheels 12, in order to accelerate the electric vehicle 10. Therefore, a power transmission path from the electric machine 18 via the pinion 22 and the output gearwheel 23 of the gearwheel arrangement 16 and the differential 20 to the driving wheels 12 is made available. The power transmission path can provide the driving wheels 12 with input power from the electric machine 18.

In a coasting operation, i.e., when the electric vehicle 10 is to be decelerated, at least a portion of the kinetic energy of the electric vehicle 10 can be made available to the electric machine 18 via the power transmission path in the drive train 15. The electric machine 18 is driven for recuperation via the power transmission path. The electric machine 18 is utilized as a generator and converts the kinetic energy of the electric vehicle 10 into electrical energy. The converted energy can be stored in batteries, capacitors, or other storing energy units (not shown here) and supplied to the electric machine 18 again as necessary, i.e., when the electric vehicle 10 is to be accelerated.

In a sailing operation, i.e., when the electric vehicle 10 is to be neither accelerated nor decelerated, essentially no power is transmitted through the power transmission path.

FIG. 2 shows a gearwheel arrangement 16 in the electric vehicle transmission 17 with the pinion 22 and the output gearwheel 23. The output gearwheel 23 has a gearwheel outer side 28, a carrier 30, a gearwheel base 24, and an outer toothing 32 at the outer side 28. The pinion 22 is arranged between the electric machine 18 and the output gearwheel 23. The pinion 22 can also be referred to as an input pinion.

Such a gearwheel arrangement 16 can be provided, for example, in an electric vehicle transmission 17, in which high ratios of up to ten (10) can be implemented using only one gearwheel pair 22, 23. Ratios of this type are advantageous, since modern electric machines can be operated with up to twenty-thousand (20,000) revolutions per minute. In this case, both a driving condition, in which the pinion 22 is driven by the electric machine 18, as well as a coasting condition, in which the pinion 22 is driven by the output gearwheel 23, preferably for the recuperation of energy, can be provided.

In the example shown, the output gearwheel 23 has a ratio of a gearwheel diameter with respect to a module in the range of approximately two hundred, eight and a half (208.5). As a result, a high ratio can be achieved using only one gearwheel pair 22, 23 by the gearwheel arrangement 16. Such small modules contribute, in particular, to ensuring that few losses occur in the gearwheel arrangement 16. In the gearwheel arrangement 16, the pinion 22 and the output gearwheel 23 have a module of one and fifty-one hundredths millimeter (1.51 mm). The ratio i_Stufe of the gear step achieved by the gearwheel arrangement 16 is eight and nine-tenths (8.9). It is understood that other ratios can also be implemented by the gearwheel arrangement 16 according to example aspects of the invention. The pressure angle between the pinion 22 and the output gearwheel 23 is twenty-four degrees (24°). This pressure angle is to be understood as an example. It is understood that the gearwheel arrangement 16 can also have other pressure angles, in particular pressure angles of approximately seventeen and a half (17.5°), as is common in vehicle transmissions. A diameter of the pinion 22 is approximately three and a half (3.5 cm). The output gearwheel 23 has a diameter of approximately thirty-one and forty-eight hundredths centimeter (31.48 cm). It is understood that the gearwheel diameters were selected for this example embodiment and other gearwheel diameters are also conceivable. The center distance between a center of the pinion 22 and a center of the output gearwheel 23 is approximately seventeen and a half centimeters (17.5 cm). It is understood that other center distances can also be selected, in particular center distances of less than ten centimeters (10.0 cm), as is common in the motor vehicle sector and the electric vehicle sector.

The aforementioned ranges and sizes are to be understood as examples for the embodiment shown in FIG. 2. Consequently, it is understood that variations result for a person skilled in the art during the utilization of the present invention.

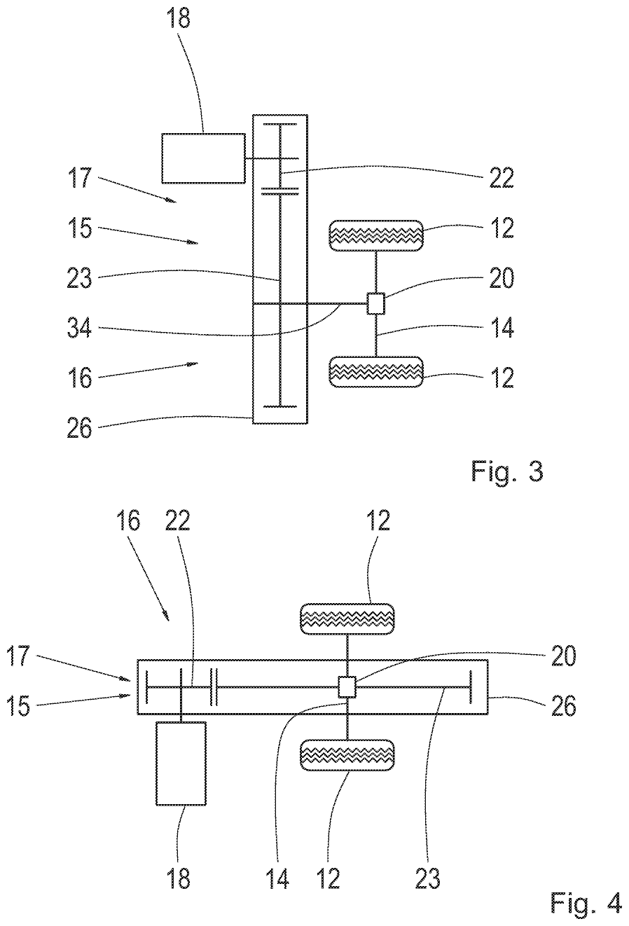

FIG. 3 shows a schematic of a drive train 15 with a gearwheel arrangement 16 according to example aspects of the present invention. Drive force is made available by an electric machine 18. The pinion 22 is rotationally fixed to an output shaft of the electric machine 18 and is in intermeshing engagement with the output gearwheel 23. The pinion 22 and the output gearwheel 23 form the gearwheel arrangement 16 according to example aspects of the invention. In this example, the output shaft of the electric machine 18 can also be considered to be an input shaft of the gearwheel arrangement 16. The output gearwheel 23 is arranged at a power transmission shaft 34 in a rotationally fixed manner. The power transmission shaft 34 transmits the input power from the gearwheel 23 to the differential 20, wherein the differential 20 then transmits the input power via the drive axle 14 onto the driving wheels 12. In this example, the power transmission shaft 34 can also be considered to be an output shaft of the gearwheel arrangement 16. It is understood that a type of all-wheel drive can also be provided, wherein the power transmission shaft 34 (power transmission axle) additionally drives a further differential, in order to drive two further wheels 12 of the electric vehicle 10.

FIG. 4 shows a schematic of a drive train 15 with a gearwheel arrangement 16 according to example aspects of the present invention. Identical reference characters relate to identical features as in FIG. 3. In the example embodiment shown in FIG. 4, the pinion 22 is also rotationally fixed to an output shaft of the electric machine 18 and is in intermeshing engagement with the output gearwheel 23. The differential 20 is connected to the output gearwheel 23 in a rotationally fixed manner in such a way that input power is supplied to the differential 20 by the output gearwheel 23, wherein the differential 20 distributes the input power to the driving wheels 12 via the drive axle 14. In this example, the drive axle 14 can also be considered to be an output shaft of the gearwheel arrangement 16. In this compact example embodiment, as compared to the embodiment shown in FIG. 3, the power transmission shaft 34 can therefore be omitted, and so the example configuration according to FIG. 4 is more compact and, preferably, also more lightweight than the configuration in the example embodiment shown in FIG. 3.

In the two example embodiments according to FIGS. 3 and 4, a holding fixture can also be provided, which, for example, is bolted onto the transmission housing 26 or cast into the transmission housing 26, wherein shaft bearings are accommodated in the holding fixture, in order to establish a maximum spacing distance of the shaft bearings and, thereby, of the transmission shafts, i.e., of the input shaft and the output shaft of the gearwheel arrangement 16. As a result, a movement apart from each other or a drifting apart of the gearwheels of the gearwheel arrangement 16, in particular in the case of a temperature increase during the operation of the drive train 15, can be thwarted. It is understood that the holding fixture can also be mounted in or at the transmission housing 26 in other ways.

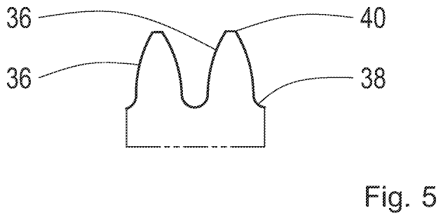

In FIG. 5, two teeth 36 of the outer toothing 32 of an output gearwheel 23 and/or of a pinion 22 of a gearwheel arrangement 16 according to example aspects of the present invention are shown. In this example embodiment, the teeth 36 have a slight addendum modification and have a module of one and fifty-one hundredths millimeter (1.51 mm). The tooth depth, i.e., the distance between the tooth root 38 and the tooth tip 40, is one and a half millimeter (1.5 mm). In this example, spur teeth were selected. This means, a helix angle β (beta) is zero degrees (0°). In this toothing, the teeth extend straight-lined in the axial direction. In the present example, a transverse contact ratio ε_{α} (epsilon_alpha) is one and a half (1.5) or less. It is understood that other tooth geometries and tooth depths can also be provided, for example, in the range from one millimeter (1.0 mm) to two and a half millimeters (2.5 mm). The gearwheel 23 and/or the pinion 22 therefore have/has a small tooth depth in relation to their/its diameter, in particular for the sector of motor vehicle transmissions.

Example aspects of the invention were comprehensively described and explained with reference to the drawings and the description. The description and the explanation are to be understood as an example and are not to be understood as limiting. The invention is not limited to the disclosed embodiments. Other embodiments or variations result for a person skilled in the art within the scope of the utilization of the present invention and within the scope of a precise analysis of the drawings, the disclosure, and the following claims.

In the claims, the words “comprise” and “comprising” do not rule out the presence of further elements or steps. The indefinite article “a” does not rule out the presence of a plurality. A single element or a single unit can carry out the functions of several of the units mentioned in the claims. The mere mention of a few measures in multiple various dependent claims is not to be understood to mean that a combination of these measures cannot also be advantageously utilized.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

10 electric vehicle
12 driving wheel
14 drive axle
15 drive train
16 gearwheel arrangement
17 electric vehicle transmission
18 electric machine
20 differential
22 pinion
23 output gearwheel
24 gearwheel base
26 transmission housing
28 gearwheel outer side
30 carrier
32 outer toothing
34 power transmission shaft
36 tooth
38 tooth root
40 tooth tip

1-9. (canceled)

10. A gearwheel arrangement (16) for establishing a gear step in an electric vehicle transmission (17), comprising:
a pinion (22) as spur gear; and
an output gearwheel (23),
wherein the pinion (22) and the output gearwheel (23) are configured as spur gears that are meshed with each other in order to effect a transmission of a drive power of an electric machine (18),
wherein a ratio of a gearwheel diameter with respect to a module of the output gearwheel (23) is no less than 140 and no greater than 350, and
wherein the pinion (22) and the output gearwheel (23) have a module no less than 1.0 mm and no greater than 1.8 mm.

11. The gearwheel arrangement (16) of claim 10, wherein the ratio of the gearwheel diameter with respect to the module of the output gearwheel (23) is no less than 205 and no greater than 230.

12. The gearwheel arrangement (16) of claim 10, wherein the module of the pinion (22) and the output gearwheel (23) is equal to 1.51 mm.

13. The gearwheel arrangement (16) of claim 10, wherein the ratio of the gear step is greater than 5.5.

14. The gearwheel arrangement (16) of claim 10, wherein the ratio of the gear step is equal to 8.9.

15. The gearwheel arrangement (16) of claim 10, wherein the pinion (22) and the output gearwheel (23) have a pressure angle no less than 20° and no greater than 28°.

16. The gearwheel arrangement (16) of claim 15, wherein the pressure angle of the pinion (22) and the output gearwheel (23) is equal to 24°.

17. The gearwheel arrangement (16) of claim 10, wherein:
one or both of the pinion (22) and the output gearwheel (23) have a tooth depth no less than 1.0 mm and no greater than 2.5 mm;
one or both of the pinion (22) and the output gearwheel (23) are made of metal; and/or
one or both of the pinion (22) and the output gearwheel (23) have an involute profile.

18. The gearwheel arrangement (16) of claim 10, wherein:
one or both of the pinion (22) and the output gearwheel (23) have a tooth depth of 1.5 mm;
one or both of the pinion (22) and the output gearwheel (23) are made of case hardened steel; and/or
one or both of the pinion (22) and the output gearwheel (23) have an addendum modification.

19. The gearwheel arrangement (16) of claim 10, wherein:
the pinion (22) has a diameter no less than 3.0 cm and no greater than 6.2 cm; and/or
the output gearwheel (23) has a diameter no less than 26 cm and no greater than 34 cm.

20. The gearwheel arrangement (16) of claim 10, wherein:
the pinion (22) has a diameter of 3.5 cm; and/or
the output gearwheel (23) has a diameter of 31.48 cm.

21. The gearwheel arrangement (16) of claim 10, wherein a center distance between a center of the pinion (22) and a center of the output gearwheel (23) is no less than 14.50 cm and no greater than 20.00 cm.

22. The gearwheel arrangement (16) of claim 10, wherein a center distance between a center of the pinion (22) and a center of the output gearwheel (23) is no less than 17.50 cm and no greater than 18.00 cm.

23. The gearwheel arrangement (16) of claim 10, further comprising an input shaft and an output shaft, wherein:
the pinion (22) is arranged at the input shaft;
the output gearwheel (23) is arranged at the output shaft;
the input and output shafts are each mounted at shaft bearings in bearing sleeves; and
a spacing distance of the bearing sleeves is predefined by a holding fixture in order to limit a drifting apart of the gearwheel arrangement (16).

24. An electric vehicle transmission (17), comprising the gearwheel arrangement (16) of claim 10, wherein the electric vehicle transmission (17) has a single gear step established by the gearwheel arrangement (16).

25. A drive train (15) for an electric vehicle (10), comprising an electric machine (18), a differential (20) and the electric vehicle transmission (17) of claim 24, wherein:
the pinion (22) is arranged at an output shaft of the electric machine (18) in a rotationally fixed manner; and
the output gearwheel (23) is arranged at an output shaft (14) or a differential (20) of the drive train (15) in a rotationally fixed manner in order to establish a drive force-transmission path from the electric machine (18) via the gear stage to the output shaft (14) or the differential (20).
